(19) United States
(12) Patent Application Publication
(10) Pub. No.: US 2003/0053639 A1
(43) Pub. Date: Mar. 20, 2003

(54) Method for improving near-end voice activity detection in talker localization system utilizing beamforming technology

(75) Inventors: Franck Beaucoup, Dunrobin (CA); Michael Tetelbaum, Ottawa (CA)

Correspondence Address: BEYER WEAVER & THOMAS LLP, P.O. BOX 778, BERKELEY, CA, 94704-0778, US

(73) Assignee: Mitel Knowledge Corporation

(21) Appl. No.: 10/222,942

(22) Filed: Aug. 15, 2002

(30) Foreign Application Priority Data
Aug. 21, 2001 (GB) 0120322.3

(51) Int. Cl. G10L 15/20; H04R 3/00; G10L 11/06; G10L 15/00

(52) U.S. Cl. 381/92; 704/233; 704/208

(57) ABSTRACT

A method for detecting voice activity comprises receiving audio signals on a plurality of channels and processing the audio signals on the channels to improve the signal-to-noise ratio thereof. The processed audio signals on each channel are then fed to associated voice activity detection algorithms and further processed. A voice or silence determination is then rendered based on at least the output of the voice activity detection algorithms. A voice activity detector is also provided.

### FIELD OF THE INVENTION

The present invention relates generally to audio systems and in particular to a method for improving near-end voice activity detection in a talker localization system that utilizes beamforming technology and to a voice activity detector for a talker localization system.

### BACKGROUND OF THE INVENTION

Localization of audio sources is required in many applications, such as teleconferencing, where the audio source position is used to steer a high quality microphone towards the talker. In video conferencing systems, the audio source position may additionally be used to steer a video camera towards the talker.

It is known in the art to use electronically steerable arrays of microphones in combination with location estimator algorithms to pinpoint the location of a talker in a room. In this regard, high quality and complex beamformers have been used to measure the power at different positions. Attempts have been made at improving the performance of prior art beamformers by enhancing acoustical audibility using filtering, etc. The foregoing prior art methodologies are described in Speaker localization using a steered Filter and sum Beamformer, N. Strobel, T. Meier, R. Rabenstein, presented at the Erlangen work shop 99, vision, modeling and visualization, Nov. 17-19th, 1999, Erlangen, Germany.

Localization of audio sources is fraught with practical difficulties. Firstly, reflecting walls (or other objects) generate virtual acoustic images of audio sources, which can be misidentified as real audio sources by the location estimator algorithms. Secondly, most known location estimator algorithms are unable to distinguish between noise sources and talkers, especially in the presence of correlated noise and during speech pauses.

Voice activity detectors that execute voice activity detector (VAD) algorithms have been used to freeze audio source localization during speech pauses so that the location estimator algorithms do not steer the microphones in spurious directions as a result of ambient noise fluctuations. This of course helps to reduce the occurrence of incorrect talker localization as a result of echo or noise.

One known prior art voice activity detector executes a single VAD algorithm that is fed with the output of a selected microphone or sub-array of microphones in the array. Selection of the microphone or sub-array of microphones that feed the VAD algorithm can be fixed, random or based on the suitability of the microphone or sub-array of microphones for the VAD algorithm. The output of the VAD algorithm is then processed to generate voice/silence decision logic output.

Another known prior art voice activity detector executes several instances of the same VAD algorithm in parallel. Each VAD algorithm receives output from a respective one of the microphones or sub-array of microphones in the array. The outputs of the VAD algorithms are combined and decision logic is used generate voice/silence decision logic output.

The performance of the VAD algorithm(s) executed by the voice activity detector significantly impacts the performance of the talker localization system both in terms of reaction speed and robustness to ambient noise. As a result, techniques to improve voice activity detection are desired.

It is therefore an object of the present invention to provide a novel method for improving near-end voice activity detection in a talker localization system that utilizes beamforming technology and a novel voice activity detector for a talker localization system.

### SUMMARY OF THE INVENTION

Accordingly, in one aspect of the present invention there is provided a method for detecting voice activity comprising the steps of:

receiving audio signals on a plurality of channels;

processing the audio signals on the channels to improve the signal-to-noise ratio thereof;

feeding the processed audio signals on each channel to an associated voice activity detection algorithm and further processing the audio signals via said voice activity detection algorithms; and

rendering a voice or silence determination based on at least the output of said voice activity detection algorithms.

Preferably, during the processing the audio signals on multiple channels are fed to a plurality of beamforming algorithm, each associated with a different look direction. Each beamforming algorithm feeds an associated voice activity detection algorithm with audio power signals.

In one embodiment the rendering is based on only the output of the voice activity detection algorithms. In another embodiment the rendering is based on both the output of the voice activity detection algorithms and the output of the beamforming algorithms. In this latter case, the rendering may be based on the output of a selected one of the voice activity detection algorithms. The selected one voice activity detection algorithm is associated with the beamforming algorithm that outputs audio power signals representing the loudest audio signals.

According to another aspect of the present invention there is provided a voice activity detector comprising:

an array of beamformers, each beamformer in said array having a different look direction and receiving audio signals on multiple channels, each beamformer processing said audio signals to improve the signal-to-noise ratio thereof;

an array of voice activity detector modules, each voice activity detector module being associated with a respective one of said beamformers and processing the output of said associated beamformer; and

logic receiving the output of said voice activity detector modules and generating output signifying the presence or absence of voice in said audio signals.

The beamformers attenuate reverberation and ambient noise in the audio signals thereby to improve the signal-to-noise ratio thereof. Preferably, the beamformers receive the audio signals from omni-directional pickups. The omni-directional pickups may be omni-directional microphone sub-arrays or individual omni-directional microphones.

The present invention provides advantages in that the performance of the voice activity detector is enhanced thereby reducing the occurrence of incorrect talker localization as a result of echo or noise. This is due to the fact that each instance of the VAD algorithm executed by the voice activity detector receives the output of a beamformer that has processed input audio signals. The directionality of the beamformers attenuate reverberation and ambient noise in the audio signals. Thus, signals fed to the VAD algorithms have a better signal-to-noise (SNR) ratio.

### BRIEF DESCRIPTION OF THE DRAWINGS

Embodiments of the present invention will now be described more fully with reference to the accompanying drawings in which:

FIG. 1 is a schematic block diagram of a talker localization system utilizing beamforming technology including a voice activity detector in accordance with the present invention;

FIG. 2 is a schematic block diagram of the voice activity detector shown in FIG. 1;

FIG. 3 is a state machine of decision logic forming part of the voice activity detector of FIG. 2;

FIG. 4 is a state machine of decision logic forming part of the talk localization system of FIG. 1; and

FIG. 5 is a state machine of an alternative embodiment of decision logic forming part of the voice activity detector of FIG. 2.

### DETAILED DESCRIPTION OF THE PREFERRED EMBODIMENTS

The present invention relates generally to a method for detecting voice activity and to a voice activity detector. Audio signals received on a plurality of channels are processed to improve the signal-to-noise ratio thereof. The processed signals are then fed to associated voice activity detection algorithms and further processed by the voice activity detection algorithms. A voice or silence determination is then rendered based on at least the output of the voice activity detection algorithms.

The present invention is suitable for use in basically any environment where it is desired to detect the presence of speech in audio signals and multiple audio pickups are available. An example of the present invention incorporated in a talk localization system will now be described.

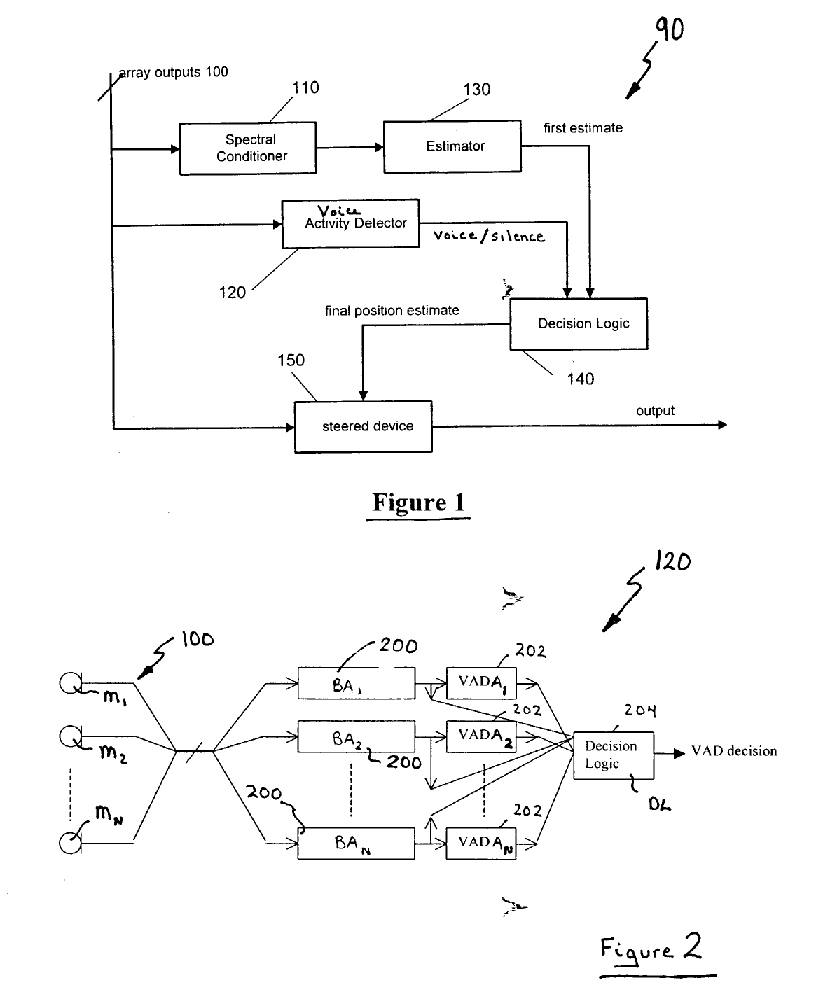

Turning now to FIG. 1, a talker localization system is shown and is generally identified by reference numeral 90. As can be seen, talker localization system 90 includes an array 100 of omni-directional microphones, a spectral conditioner 110, a voice activity detector 120, an estimator 130, decision logic 140 and a steered device 150 such as for example a beamformer, an image tracking algorithm, or other system.

The omni-directional microphones in the array 100 are arranged in circular microphone sub-arrays, with the microphones of each sub-array covering hundreds of segments of a 360° array. The audio signals output by the circular microphone sub-arrays of array 100 are fed to the spectral conditioner 110, the voice activity detector 120 and the steered device 150.

Spectral conditioner 110 filters the output of each circular microphone sub-array separately before the output of the circular microphone sub-arrays are input to the estimator 130. The purpose of the filtering is to restrict the estimation procedure performed by the estimator 130 to a narrow frequency band, chosen for best performance of the estimator 130 as well as to suppress noise sources.

Estimator 130 generates first order position estimates, by segment number, as is known from the prior art and outputs the position estimates to the decision logic 140. During operation of the estimator 130, a beamformer instance is “pointed” at each of the positions (i.e. different attenuation weightings are applied to the various microphone output audio signals). The position having the highest beamformer output is declared to be the audio signal source. Since the beamformer instances are used only for energy calculations, the quality of the beamformer output signal is not particularly important. Therefore, a simple beamforming algorithm such as for example, a delay and sum beamformer algorithm can be used, in contrast to most teleconferencing implementations, where high quality beamformers executing filter and sum beamformer algorithms are used for measuring the power at each position. Specifics of the spectral conditioner 110 and estimator 130 are described in U.K. Patent Application No. 0016142 filed on Jun. 30, 2000 for an invention entitled “Method and Apparatus For Locating A Talker”. Accordingly, further details of the spectral conditioner 110 and estimator 130 will not be described further herein.

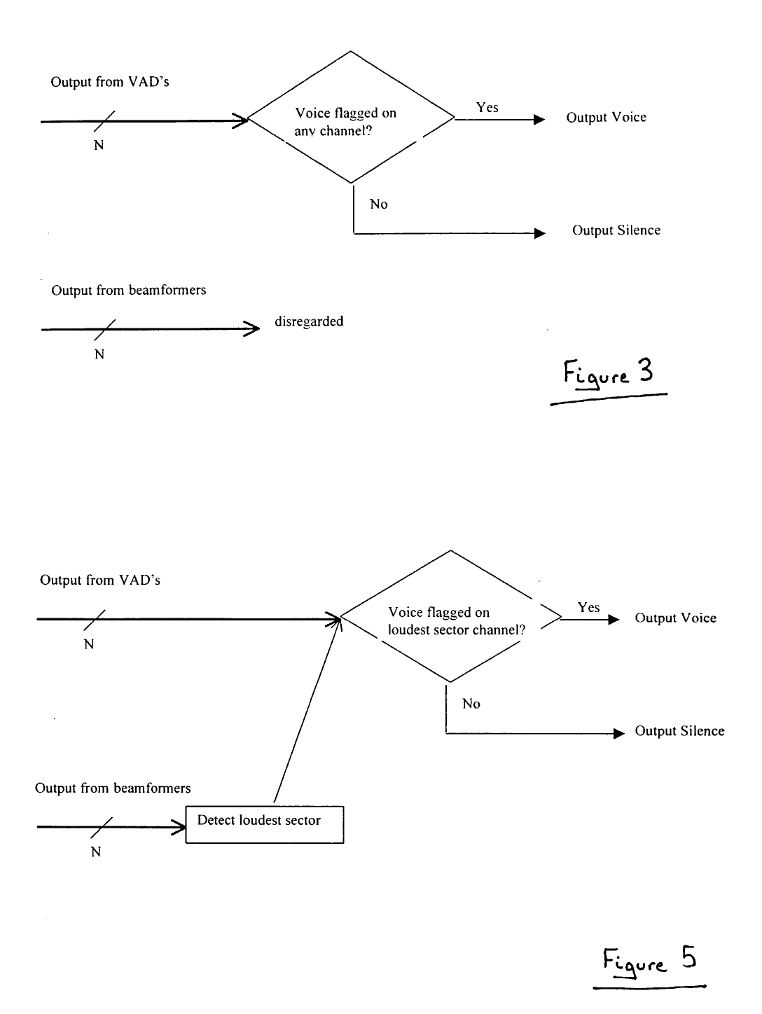

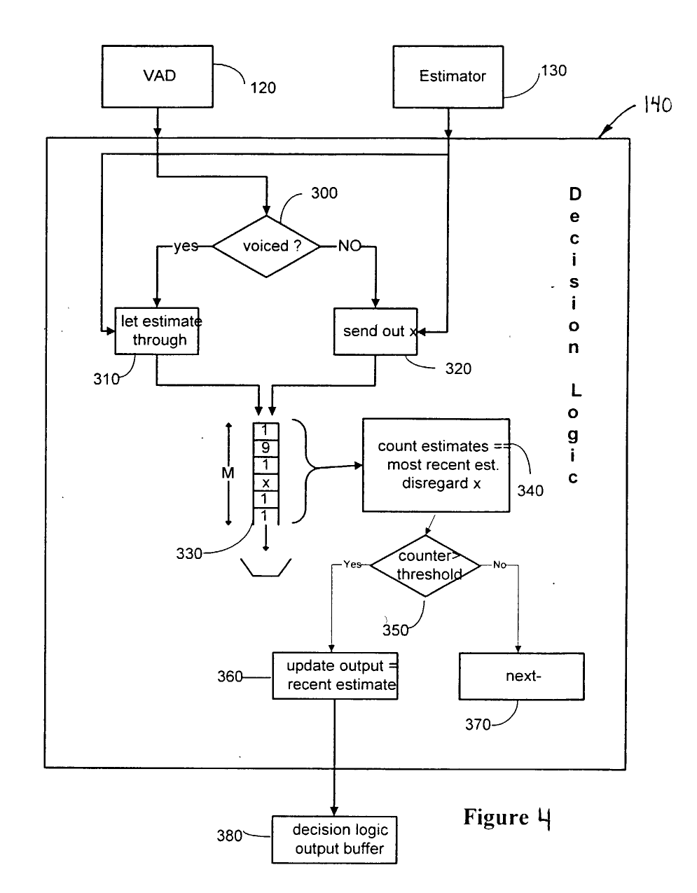

Voice activity detector 120 determines voiced time segments in order to freeze talker localization during speech pauses. As can be seen in FIG. 2, voice activity detector 120 includes an array of beamformers 200, each executing an instance of a conventional beamforming algorithm BA_{N}, where N is the number of beamformers 200 in the array. Each beamforming algorithm BA_{N} has a different “look direction” corresponding to the segments of the microphone array 100. Each beamforming algorithm BAN processes the audio signals on its channel that are received from the circular microphone sub-arrays M_{N} to generate audio power signals. During this processing, reverberation and ambient noise in the audio signals is attenuated. As a result, the signal-to-noise (SNR) ratio of audio signals output by the circular microphone sub-arrays is improved.

Voice activity detector 120 further includes an array of voice activity detector (VAD) modules 202, each executing an instance of a VAD algorithm VADA_{N}. Each VAD module 202 receives the output of a respective one of the beamformers 202. Since the signals received by the VAD modules 202 from the beamformers 200 have improved SNR, the performance of the VAD algorithms is enhanced. The outputs of the beamformers 200 and the outputs of the VAD modules 202 are conveyed to decision logic 204.

The decision logic 204 executes a decision logic algorithm and in response to the outputs of the VAD modules 202 generates either voice or silence decision logic output. FIG. 3 is a state machine showing the decision logic algorithm executed by the decision logic 204. As can be seen, in this embodiment, the outputs of the beamformers 200 are discarded. The outputs of the VAD modules 202 are however examined to determine if one or more of the VAD algorithms have generated output signifying the presence of voice picked up by one or more of the circular microphone sub-arrays. The logic output generated by the decision logic 204 is conveyed to the decision logic 140.

Decision logic 140 is better illustrated in FIG. 14 and as can be seen, decision logic is a state machine that uses the output of the voice activity detector 120 to filter the position estimates received from estimator 130. The position estimates received by the decision logic 140 when the voice activity detector 120 generates silence decision logic output i.e. during pauses in speech, are disregarded (steps 300 and 320). Position estimates received by the decision logic 140 when the voice activity detector 120 generates voice decision logic output are stored (step 310) and are then subjected to a verification process. During the verification process, the decision logic 140 waits for the estimator 130 to complete a frame and repeat its position estimate a threshold number of times, n, including up to m<n mistakes.

A FIFO stack memory 330 stores the position estimates. The size of the stack memory and the minimum number n of correct position estimates needed for verification are chosen based on the voice performance of the voice activity detector 120 and estimator 130. Every new position estimate which has been declared as voiced by voice activity detector 120 is pushed into the top of FIFO stack memory 330. A counter 340 counts how many times the latest position estimate has occurred in the past, within the size restriction M of the FIFO stack memory 330. If the current position estimate has occurred more than the threshold number of times, the current position estimate is verified (step 350) and the estimation output is updated (step 360) and stored in a buffer (step 380). If the counter 340 does not reach the threshold n, the counter output remains as it was before (step 370). During speech pauses no verification is performed (step 300), and a value of 0xFFFFF(xx) is pushed into the FIFO stack primary 330 instead of the position estimate. The counter output is not changed.

The output of the decision logic 140 is a verified final position estimate, which is then used by the steered device 150. If desired, the decision logic 140 need not wait for the estimator 130 to complete frames. The decision logic 140 can of course process the outputs of the voice activity detector 120 and estimator 130 generated for each sample.

As will be appreciated, the voice activity detector 120 provides for more accurate voice or silence determination regardless of the VAD algorithms executed by the VAD modules 202 due to the fact that the VAD algorithms process signals with improved SNR. The degree to which the voice or silence determination is improved depends on the degree of directionality of the beamforming algorithms executed by the beamformers 200.

Turning now to FIG. 5, the state machine of an alternative embodiment of a decision logic algorithm executed by the decision logic 140 is shown. As can be seen, in this embodiment, the outputs of the beamformers 200 are examined to determine the beamformer 200 that receives the loudest audio signals. The output of the VAD module 202 that receives the output from the determined beamformer 200 is then examined to determine if the output signifies voice in the audio signals.

Although specific examples of decision logic algorithms are described, those of skill in the art will appreciate that other logic can be used to process the outputs of the beamformers 200 and VAD modules 202 to render a voice or silence determination. Also, although the beamformers 200 are described as receiving output from audio pickups in the form of circular microphone sub-arrays, each beamformer 200 can receive the output from individual omni-directional microphones. Furthermore, although the voice activity detector is shown and described with reference to a specific talk localization system, those of skill in the art will appreciate that the voice activity detector 120 can be used in basically any environment where several audio pickups are available and it is desired to detect the presence of speech in audio signals.

Although preferred embodiments of the present invention have been described, those of skill in the art will appreciate that variations and modifications may be made without departing from the spirit and scope thereof as defined by the appended claims.

What is claimed is:

1. A method for detecting voice activity comprising the steps of:
receiving audio signals on a plurality of channels;
processing the audio signals on the channels to improve the signal-to-noise ratio thereof;
feeding the processed audio signals on each channel to an associated voice activity detection algorithm and further processing the audio signals via said voice activity detection algorithms; and
rendering a voice or silence determination based on at least the output of said voice activity detection algorithms.

2. The method of claim 1 wherein during said processing the audio signals on multiple channels are fed to beamforming algorithms, each beamforming algorithm being associated with a different look direction and feeding an associated voice activity detection algorithm with audio power signals.

3. The method of claim 2 wherein said rendering is based on only the output of said voice activity detection algorithms.

4. The method of claim 2 wherein said rendering is based on both the output of said voice activity detection algorithms and the output of said beamforming algorithms.

5. The method of claim 4 wherein said rendering is based on the output of a selected one of said voice activity detection algorithms, said selected one voice activity detection algorithm being associated with the beamforming algorithm outputting power information signals representing the loudest audio signals.

6. The method of claim 1 wherein said audio signals are received on said channels through omni-directional audio pickups.

7. A voice activity detector comprising:
an array of beamformers, each beamformer in said array having a different look direction and receiving audio signals on multiple channels, each beamformer processing said audio signals to improve the signal-to-noise ratio thereof;
an array of voice activity detector modules, each voice activity detector module being associated with a respective one of said beamformers and processing the output of said associated beamformer; and
logic receiving the output of said voice activity detector modules and generating output signifying the presence or absence of voice in said audio signals.

8. A voice activity detector according to claim 7 wherein said beamformers attenuate reverberation and ambient noise in said audio signals.

9. A voice activity detector according to claim 8 wherein said beamformers receive said audio signals from omni-directional pickups.

10. A voice activity detector according to claim 9 wherein said omni-directional pickups are omni-directional microphone sub-arrays.

11. A voice activity detector according to claim 9 wherein said omni-directional pickups are omni-directional microphones.

12. A voice activity detector according to claim 7 wherein said logic further receives the output of said beamformers.

13. A voice activity detector according to claim 12 wherein said logic generates said output based on the outputs of said voice activity modules and said beamformers.
